(19) United States
(12) Patent Application Publication
(10) Pub. No.: US 2025/0044231 A1
(43) Pub. Date: Feb. 6, 2025

(54) METHOD FOR BUILDING OF A SERS SUBSTRATE FROM METALLIC NANOPARTICLES, SERS SUBSTRATE, AND USE THEREOF

(71) Applicants: PETRÓLEO BRASILEIRO S.A. – PETROBRAS, Rio de Janeiro (BR); SERVIÇO NACIONAL DE APRENDIZAGEM INDUSTRIAL – DEPARTAMENTO REGIONAL DE MINAS GERAIS, Belo Horizonte (BR)

(72) Inventors: Monica TEIXEIRA DA SILVA, Rio de Janeiro (BR); Ana Clara SAMPAIO PIMENTA, Belo Horizonte (BR); Mariana BOTELHO BARBOSA, Belo Horizonte (BR); Felipe BATISTA ALVIM, Rio de Janeiro (BR); Stefan SUAREZ FERREIRA, Rio de Janeiro (BR); Giselle Maria LOPES LEITE DA SILVA, Rio de Janeiro (BR); Rosane ALVES FONTES, Rio de Janeiro (BR); Isabela Maria FERREIRA LOPES, Belo Horizonte (BR); Camila Cristina ALMEIDA DE PAULA, Belo Horizonte (BR); Ana Carolina CATARINO DO CARMO, Belo Horizonte (BR); Izabela Diniz PADULA, Belo Horizonte (BR); Jussara DE MELLO SILVA, Rio de Janeiro (BR); Linus PAULING DE FARIA PEIXOTO, Belo Horizonte (BR); Luiz Alexandre SACORAGUE, Rio de Janeiro (BR); Alexandre BARBOSA MELO DE CARVALHO, Rio de Janeiro (BR); Tiago CAVALCANTE FREITAS, Rio de Janeiro (BR)

(21) Appl. No.: 18/760,632

(22) Filed: Jul. 1, 2024

(30) Foreign Application Priority Data
Aug. 4, 2023 (BR) 1020230157416

(51) Int. Cl. G01N 21/65

(52) U.S. Cl. CPC G01N 21/658

(57) ABSTRACT

The present disclosure refers to a method for building a SERS substrate from metal nanoparticles for determining the content of phosphonate-based scale inhibitors present at low concentrations in water using surface-enhanced Raman spectroscopy (SERS). The substrates also are used in detergent and dispersant products, in corrosion inhibitors and in water treatment systems in general, such as cooling water and boiler water, in addition to being applied in other fields such as the textile, concrete and paper industries.

### FIELD OF THE DISCLOSURE

The present disclosure falls within the field of oil and gas production, more precisely in the field of determining the residual scale inhibitors based on organic phosphonates in produced water streams, and refers to a method for building a SERS substrate from metallic nanoparticles for determining the content of phosphonate-based scale inhibitors present at low concentrations in water using surface-enhanced Raman spectroscopy (SERS). The substrates are also used in detergent and dispersant products, in corrosion inhibitors and in water treatment systems in general, such as cooling water and boiler water, in addition to being applied in other fields such as the textile, concrete and paper industries.

### BACKGROUND OF THE DISCLOSURE

During oil production different types of chemicals are added with the aim of complying with the legislative requirements, operational safety during transportation and production, the elimination or minimization of waste produced and product quality. In this context, organic compounds containing phosphonate, sulfur and carboxyl groups are commonly used as scale inhibitors by forming inorganic salt precipitates that can adhere to the pipe walls and production equipment. The use of suitable amounts of scale e inhibitors is extremely important, as products in excess or in quantities below the recommended levels in addition to increasing production costs can cause operational issues.

Scale inhibitors when used in very high quantities can increase the stringency of the environment resulting in the triggering of corrosive processes. Dosages below those recommended may not be efficient in inhibiting the deposition of solids in production equipment. Therefore, the addition of suitable amounts of these compounds is essential to avoid problems caused by the presence of residues. However, the current existing methodologies for determining the correct dosage of these compounds are not very applicable and highly complex. Therefore, there is a need to develop simple, low-complexity and low-cost analytical methodologies to determine the concentration of products in process streams as a tool in routine inspection and monitoring activities of processes in oil and gas production.

In this context, surface-enhanced Raman spectroscopy (SERS) has great potential, as it is a highly sensitive vibrational spectroscopy technique that allows the detection of analytes at low concentrations. Furthermore, the availability of handheld Raman spectrometers on the market and the simplicity of the technique contribute to the possibility of using it in field laboratories.

Currently, the determination of phosphonate-based scale inhibitors is only carried out indirectly through the determination of the phosphorus content. However, this parameter alone does not guarantee the correct concentration of chemical product, as other phosphorus-based compounds used in the production of inhibitors are present in the commercial product formulation.

Furthermore, the methodologies that allow one to determine the phosphorus content are based on Inductively

Coupled Plasma Atomic Emission Spectrometry (ICP-AES), which uses complex equipment that makes analysis difficult or impossible in field laboratories. Other methods described in the literature for detecting these products use chromatographic techniques, such as high-performance liquid chromatography or ionic chromatography. However, in addition to being unfeasible for routine use in field operations, such techniques present difficulties and low reproducibility in applications involving complex matrices, such as produced water.

Phosphonate compounds are anions derived from phosphonic acids. Such acids have in their structure the R—CP(O)(OH)₂ group having a covalent and stable bond between carbon and phosphorus. The most used ones are derivatives of aminopolycarboxylate acetate (EDTA), nitrilotriacetate (NTA) and diethylenetriaminepentaacetate (DTPA) (NOWACK, 2003; SCHMIDT et al., 2014). Phosphonate compounds are also chelating agents capable of reacting with alkaline, alkaline earth and heavy metals (KLINGER et al., 1997), therefore having high affinity for mineral surfaces. Accordingly, they are used in various applications including: in the production of detergents and the like, in the metal and oil industry, as corrosion inhibitors, in the production of cosmetics, paper, textiles, construction materials and, finally, as scale inhibitors (ARMBRUSTER et al., 2020).

Scaling, together with corrosion, are phenomena that have major impacts on industrial water treatment (JAFAR MAZUMDER, 2020). In the fouling process, the solid layer formed on the surface of equipment and pipes leads to increased operational costs and a loss of efficiency in their applications, such as in oil fields (OSHCHEPKOV et al., 2020).

The most common salts that contribute to scaling are sulfates and carbonates. In general, sulfates are precipitated by mixing the injection water (rich in sulfate anions) with the formation water (rich in cations, such as barium, calcium and strontium). On the other hand, carbonates are precipitated due to changes that occur in the process, such as variation in temperature, pressure or pH (ROSA et al., 2015). The petrochemical industry has great interest in these inhibitors and, therefore, is always searching for new products and a broad understanding of the mechanism by which these compounds function. Such actions are extremely important, as they can offer more possibilities for treating the water used in extraction processes and collaborate better on economic viability (ROSA et al., 2015).

Although the permitted/expected concentration limits in the environment present low toxicity and danger, and do not contribute to bioaccumulation, the biodegradation process of phosphonate inhibitors is very slow (ARMBRUSTER et al., 2020). Furthermore, the high cost associated with these compounds as well as the complexity of operations combined with applications, make the precise determination of the amounts to be used an extremely important condition sought by petrochemical industries. The goal is to avoid unnecessary expenses in addition to possible impacts on the environment (OSHCHEPKOV et al., 2020). The methods currently described in the literature for detecting phosphonate scale inhibitors use chromatographic techniques such as high-performance liquid chromatography or ion chromatography. However, in addition to being unfeasible for routine use in field operations, for example, such techniques present difficulties concerning applications involving complex matrices (SCHMIDT et al., 2014), as is the case with crude oil.

Thus, as a low complexity and low cost alternative is surface-enhanced Raman spectroscopy (SERS), which is a powerful technique applied in the detection of various molecules such as dyes, pesticides, drugs and biomolecules, among others. The technique is capable of detecting low concentrations, reaching the detection of a single molecule. Furthermore, SERS is capable of conferring structural information also being a fingerprint technique (CAMARGO et al., 2010; SANTINOM et al., 2018). The main enhancement generated by the SERS effect is based on the localized surface plasmon resonance (LSPR) present in metallic nanostructures. LSPR enhances the Raman signal close to the metal surface due to the large increase in the local electromagnetic field generated by the surface plasmon oscillation (HE et al., 2017).

Therefore, for the SERS effect to take place a metallic surface is required. Some companies sell SERS substrates, such as Real-Time Analyzers Company, which was the first to market and one of its first products were glass containers internally covered with sol-gel material active for SERS. The same company currently produces glass capillaries coated with gold or silver for detecting cocaine in saliva. Horiba Scientific sells substrates coated with gold nanorods obtained by oblique dynamic vacuum evaporation. Silmeco is a nanotechnology company specialized in the production of SERS substrates formed by silicon nanopillars coated with gold or silver. Mesophotonics was one of the first companies to develop substrates prepared lithographically by producing patterns of pyramidal shapes on silicon. OndaVia company sells specific kits that combine microfluidics devices for separating complex samples and nanoparticle suspensions. None of these companies sell substrates for detecting phosphonate-based compounds.

Thus, in the present disclosure, a surface-enhanced Raman spectroscopy (SERS) method is developed using active SERS substrates based on metal nanoparticle suspensions for signal enhancement in analyzes of phosphonate-based scale inhibitors by Raman spectroscopy. As it is a highly selective and sensitive vibrational spectroscopy technique, it allows one to detect and quantify low concentrations of scale inhibitors by using a low complexity and low cost method that enables one to carry out analyzes using handheld systems in the field.

### STATE OF THE ART

Document U.S. Pat. No. 10,739,269B2 is directed to a method for detecting chemicals and, in particular, a method of using Surface Enhanced Raman Spectroscopy (SERS) to detect, identify and/or determine trace amounts of chemicals in oil and gas applications. The aforementioned document notes that the SERS technique is particularly suitable for the analysis of well treatment additives, example, for scales and corrosion inhibitors in brine. SERS can be used to distinguish between different phosphonate-based chemicals, such as those found in scale inhibitors at low concentrations as well as other trace chemicals. The described method allows one to detect and quantify chemicals down to 1 part per million (ppm). The method uses functionalized metal nanoparticles as a SERS substrate, and includes gold, silver or a combination thereof.

However, said document shows the use of functionalized metal nanoparticles as a SERS substrate, the synthesis being carried out by chemical reduction using glycine or aspartic acid. Accordingly, it can be inferred that the substrate used has significant differences in relation to the object of the present disclosure, from the nanoparticle synthesis methodology using different reagents to need the for their functionalization. Furthermore, said document states that for SERS analysis it is necessary to use functionalized nanoparticles. For the present disclosure, the use of nanoparticles with no functionalization presents an advantage since no additional steps are required to achieve the nanoparticles, hence simplifying the method described herein. The method that consists of using purified and diluted nanoparticles to build a substrate that promotes interaction between nanoparticles/analyte for subsequent SERS analysis is an innovation over document U.S. Pat. No. 10,739,269B2. Furthermore, it is noteworthy that SERS analysis takes place on the edge of the droplet after drying the metal nanoparticle and the sample containing the scale inhibitor. Therefore, it is noted that the construction of the SERS substrate and the analysis methodology used in document U.S. Pat. No. 10,739,269B2 are different from that presented herein.

Document U.S. Pat. No. 9,804,076B2 relates to a method for monitoring at least one industrial fluid at the industrial fluid site by introducing an industrial fluid sample into a device employing a technique for detecting at least one composition of the sample. The industrial fluid may be or include a refinery fluid, a production fluid, cooling water, process water, drilling fluids, completion fluids, production fluids, crude oil, feed streams to desalting units, outflow from desalting units, refinery heat transfer fluids, gas scrubber fluids, refinery unit feed streams, refinery intermediate streams, finished product streams, and combinations thereof. Among the possible techniques to use is SERS, where gold nanoparticles are incorporated into the capillary or microchannel to allow trace-level detection of a composition of interest, which may even be a phosphonate.

The aforementioned document states that SERS is a possible technique for detecting contaminants in industrial processes, however the only substrate described for this purpose uses gold nanoparticles incorporated into an OndaVia capillary, which is used to detect monoethanolamine (MEA).

The substrate proposed in the present disclosure has very different structural, chemical and morphological characteristics, as it uses a silver nanoparticle suspension that is dripped onto a silicon substrate. Furthermore, application in aforementioned document is exclusive to one molecule—MEA, an amine/alcohol that has no phosphonate groups in its structure.

The present disclosure considers another molecule, which is essential for effectiveness of the application.

SERS substrates are built with different properties depending on the molecule of interest. Changing the molecule of interest requires a new disclosure, since all properties of the system need to be changed and this is the biggest challenge in achieving efficiency. Therefore, the aforementioned document has major differences compared to the proposed disclosure, from the substrate (structure, chemical composition, morphology and components) to the chemical group of the molecule of interest for analysis.

Document WO2020227079A1 refers to methods and systems capable of detecting, quantifying and/or monitoring corrosion inhibitors used to protect metal surfaces in oil and gas production and in refining processes. More specifically, said document is directed to the use of Surface Enhanced Raman Spectroscopy (“SERS”) to detect, quantify and/or monitor corrosion inhibitor formulations, which are present in a wide range of concentrations in highly ionic fluids, in order to manage corrosion treatment in oil and gas production and in refining processes. SERS substrates comprise metallic particles including, without limitation, gold nanoparticles, silver nanoparticles, among others.

As already discussed, the aforementioned document uses functionalized nanoparticles; in addition, it demonstrates that the methodology was designed for another class of chemical compounds, thiol, and the inventive step proposed in the present disclosure aims at the phosphonate group. The chemical group is responsible for the interaction of the target molecule with the substrate. Such an interaction is essential for the efficiency of SERS substrates, which means that methodologies that enable this interaction are always a challenge. As previously discussed, the aforementioned document does not present the same proposal as the present disclosure, since for the detection of thiol-type products by SERS the use functionalized nanoparticles is required.

The document to MURUGESAN et al., entitled “Next Generation On-Site Scale Inhibitor Analysis—Surface Enhanced Nanotechnology Detection” proposes the development of a method using handheld instrumentation for the detection and quantification of scale inhibitors in the field using Surface Enhanced Raman Spectroscopy (SERS) to detect low concentrations of different scale inhibitor chemicals in brine, including phosphonates. As SERS substrates they use functionalized metal nanoparticles, for example, gold nanoparticles.

However, this document differs from the present disclosure due to the need to use functionalized gold nanoparticles in suspension, while in the proposed disclosure silver nanoparticles are used directly dripped onto a silicon substrate. Thus, although SERS analysis is used in the detection of phosphonates, the SERS substrate differs from that of the present disclosure with respect to chemical composition, nanoparticle morphology, synthesis methodology, sample preparation and substrate components.

The document to WANG et al., entitled “Synthesis of silver nanocubes as a SERS substrate for the determination of pesticide paraoxon and thiram”, refers to the synthesis of silver nanocubes to be used as a SERS substrate for the determination of the pesticides paraoxon and thiram. Although this study aims to detect products different from those of the present disclosure, it employs a similar technique for the synthesis of the SERS substrate, that is, chemical reduction, in which AgNO₃ is reduced to Ag by anhydrous ethylene glycol (EG) in the presence of poly(vinyl pyrrolidone) (PVP) and a trace amount of Na₂S.

Moreover, the document to GARCÍA-BARRASA et al., entitled “Silver nanoparticles: synthesis through chemical methods in solution and biomedical applications”, reviews the methods used for the synthesis of silver nanoparticles and mentions, among others, the chemical reduction of silver nitrate in ethylene glycol in the presence of polyvinylpyrrolidone.

However, both Wang and Garcia-Barrasa, despite being related to the synthesis of nanoparticles, do not propose a methodology for building SERS substrates and SERS analysis for detecting phosphonate-type scale inhibitors, as in the present disclosure. As already described, this methodology involved the step of choosing the most appropriate type of nanoparticle for the end purpose (silver nanocubes), the step of purification and dilution to optimize the amount of material used to build the substrate and the step of interaction between the nanoparticle and the analyte. The synthesis of metal nanoparticles is not innovative and the focus is not on the synthesis, but on the use of nanoparticles having specific morphology, chemical composition and concentration that, when deposited on a silicon substrate, promote effective interaction and the detection of phosphonate analytes via SERS analysis.

### BRIEF DESCRIPTION OF THE DISCLOSURE

The present disclosure aims to propose a method for building a SERS substrate from metal nanoparticles for determining the content of phosphonate-based scale inhibitors present at low concentrations in water using surface-enhanced Raman spectroscopy (SERS).

### BRIEF DESCRIPTION OF THE FIGURES

To provide a total and full visualization of the goal of the present disclosure, the figures are presented below, which are referred to herein, as follows.

FIG. 1 depicts a schematic diagram of the sample analysis methodology using the proposed SERS method.

FIG. 2 depicts confocal microscopy images of the NCsAg droplet after drying at 100× magnification (A) 2D image (B) 3D image (C) 3D height image.

FIG. 3 shows a UV-Vis spectrum of the suspension of silver nanocubes (NCsAg) right after synthesis. Inset: digital image of the suspension.

FIG. 4 shows UV-Vis spectra of the NCsAg suspension without purification over time.

FIG. 5 shows scanning electron micrographs of the NCsAg suspension.

FIG. 6 shows Raman spectra for ATMP solutions at different concentrations.

FIG. 7 depicts SERS spectra for ATMP with NCsAg as active substrates.

### DETAILED DESCRIPTION OF THE DISCLOSURE

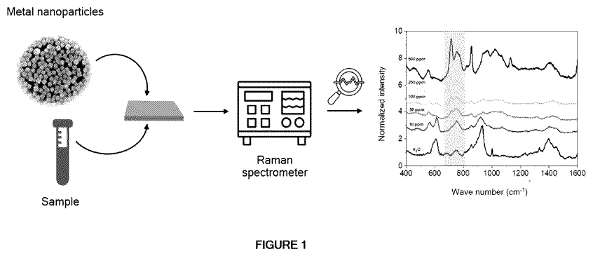

The present disclosure refers to a method for building a SERS substrate from metal nanoparticles for determining the content of phosphonate-based scale inhibitors present at low concentrations in water using surface-enhanced Raman spectroscopy (SERS), as shown in FIG. 1. Said method comprises the following steps:
(a) Selecting the metal nanoparticles;
(b) purifying and preparing the nanoparticles; and
(c) interaction between the analyte and substrate.

The steps of the performed method will be described in more detail below.

### (a) Selecting the Metal Nanoparticles

The metals used for synthesis can be silver, gold or a combination thereof. Nanoparticles that exhibited the best results in the development of the method of analysis were silver nanoparticles having a cubic shape.

Considering SERS substrates that are built from metal nanoparticles suspensions, the choice of the method for obtaining the suspension must ensure that the two effects mentioned above occur efficiently. Such an efficiency is directly related to the interaction between nanoparticle/analyte and depends on factors such as size, chemical composition, morphology, stabilizing and functionalizing agents of the process of synthesis of nanostructures.

Synthesis of these metal nanoparticles (NPs) is carried out via chemical reduction using a reflux system. A two-necked 50 mL round bottom flask is placed in a glycerin bath at 160° C. 15 mL of anhydrous ethylene glycol are added and heated and gently stirred for one hour, while maintaining the temperature at about 142° C. While ethylene glycol is heated, solutions of 48 mg/ml AgNO₃ (0.284 mol L⁻¹), 3 mM Na₂S (3 mmol L⁻¹) and 20 mg/ml PVP [poly(vinyl pyrrolidone), MM*55000, 0.363 mmol L⁻¹] are prepared, as the solutions must be used fresh.

After heating, 80 μL of Na₂S are added to the flask and, after 9 minutes, 3.75 mL of PVP are added. Then, 1.25 mL of AgNO₃ are dripped onto the solution, with a drip duration of 1 minute. The suspension reacts for 15 minutes, is cooled down in a water bath for about 5 minutes and stored in the refrigerator.

The main characteristic that a metallic nanoparticle must present to be efficient as a SERS substrate is the possibility of causing an intensification of the local electromagnetic field when there is incidence of radiation on the nanoparticle in contact with the molecule of interest. Two effects are known to contribute to such an intensification:
the LSPR (localized surface plasmon resonance) effect, which allows intensification of the local electromagnetic field of the metal surface;
chemical interaction between the nanoparticle and the molecule of interest, where a surface complex is formed resulting in a charge transfer process (PILOT et al., 2019).

### (b) Purifying and Preparing the Nanoparticles

To build SERS substrates, the nanoparticles must be purified and diluted after synthesis, in order to remove residual synthesis impurities and reach the appropriate concentration of nanoparticles for building the substrate (optimization of the amount of NP matter).

Purification and dilution were carried out in the same sequence of events that involved different washing solvents and, consequently, reducing the amount of nanoparticle matter in the final suspension. Thus, 1.5 mL of nanoparticles are added to 4.5 mL of acetone P.A. and this mixture (1:3 ratio of nanoparticles to acetone P.A., respectively) is centrifuged at 3000 g for 30 min. Then, the supernatant is removed up to approximately 100 μl and 1.5 mL of P.A. ethanol is added. (up to ⅓ of the initial volume was reached). The mixture is taken to ultrasound and homogenized for 2 min and centrifuged at 10,000 g for 10 min. Next, the process of removing the supernatant and redispersing it in ethanol is repeated two more times at the ratios described. Finally, the final supernatant was removed and discarded until 0.8% of the initial volume was reached, followed by ultrapure water being added until ⅙ of the initial volume was reached.

The final suspension was homogenized in ultrasound for 2 minutes.

### (c) Interaction Between the Analyte and Substrate

After obtaining stable and purified suspensions of nanoparticles, the next steps for applying the method are: building the substrate, deposition of the analyte and detection of the analyte based on the interaction with the substrate and the SERS effect generated by the laser incidence from the Raman spectrometer.

There are several methods to increase the Raman enhancement of the molecule of interest. One of them is the controlled aggregation of metallic nanoparticles with the addition of aggregating molecules, centrifugation and concentration or concentration in droplet form, the so called edge effect or coffee ring. In this method, a droplet or more droplets of the nanoparticle suspension are deposited on a substrate and dried by evaporating the solvent. Due to the drying effect, the nanoparticles concentrate at the edge of the droplet. Subsequently, the analyte is also dripped onto these nanoparticles and its molecules preferentially migrate towards the edge, the region with a greater amount of nanoparticles.

Raman analysis of the sample of interest is performed in the edge region, as this is the active region of the SERS substrate that has the highest concentration of nanoparticles and analyte. Thus, there is greater interaction between the two and the SERS effect generated is more significant, allowing the detection of the analyte of up to 2 mg kg⁻¹ using chemometric analyses.

The method of interaction between the nanoparticles and the analyte of interest for building the SERS substrates was carried out based on the concentrations of metallic nanoparticles. To this end, first 5 μL of the suspension are dripped onto a polycrystalline silicon substrate and, after 1 h of drying, 5 μL of the analyte of interest are poured dropwise (standard solution of phosphonate compounds in different concentrations). Analyzes were carried out after the second drop containing the analyte solution had completely dried (about 1 h). Interaction must be carried out in an environment with around 30% humidity and a temperature of 20° C.

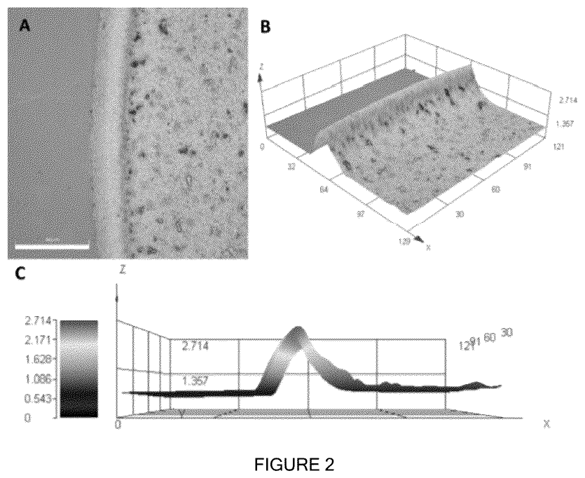

In order to further evaluate the edge of the droplets after the nanoparticles dripping, measurements were taken using a confocal microscope of the height and thickness of these edges. These parameters are important to better understand the enhancement t this point on the edge and to assess the reproducibility of different built substrates. FIG. 2 shows the confocal images at 100× magnification obtained to measure the edge thickness and dry drop height. The NCsAg droplet has an average thickness of 27.01±1.38 μm (20 measurements were taken) and a maximum average height of 1.84±0.12 μm (10 points). These results confirm that at the edge of the droplets there is a greater concentration of material, consequently hot spots and, therefore, there is greater intensification of the SERS signal.

Performance analysis of SERS substrates is carried out at the edge of the dry droplet (coffee ring effect) and at least 3 distinct regions are selected. For surface-enhanced Raman (SERS) analysis, a commercial Raman microspectrometer with a resolution of at least 1 cm⁻¹ was used. In a simplified manner, the optical assembly consists of dielectric mirrors suitable for the excitation wavelength, an edge filter to filter the radiation originating from elastic scattering and lenses to collimate and focus the sample emission. The edge of the sample was excited with a laser line centered at 785 nm at 300 μW power. Measurements were carried out in backscatter geometry, in such a way that the same 50× long-distance objective (NA 0.50) focuses the laser and collects the emission from the sample. Such an emission was filtered and dispersed on a diffraction grid of 1200 lines/mm and then analyzed by the equipment's software. The spectra were collected at an acquisition time of 30 s and 3 accumulations in the 400-1600 cm⁻¹ region. It is worth mentioning that the parameters used to achieve the results can be changed and the analyte is still detected when it is contacted with the manufactured SERS substrate.

### Assessment of the SERS Substrates

In order to ensure quality and plasmonic resonance of the nanoparticles, they are characterized by ultraviolet-visible absorption spectroscopy and scanning electron microscopy (SEM) techniques.

Optical characterization through absorption spectroscopy in the UV-Vis region is essential to assess quality of the synthesis of active SERS substrates. Through the spectral profile it is possible to obtain information about morphology, size and distribution, in addition to assess stability over time.

As an example, characterizations of cubic-type nanoparticles will be presented, but for the disclosure, different morphologies can be synthesized, such as spheres and cubes. As previously mentioned, the metals used for synthesis can be silver, gold or a combination of both, however, the results of silver nanoparticles will be presented as an example.

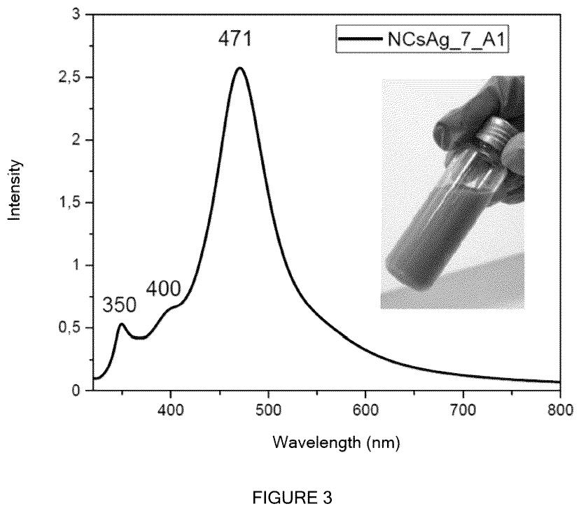

The absorption spectrum in the ultraviolet visible (UV-Vis) region and the digital image of the aliquot of synthesized NPs are shown in FIG. 3. The synthesized NPs presented a spectral profile characteristic of nanocubes (NCs) with an intense and thin band at 471 nm, a shoulder at 400 nm and another band at 350 nm. These bands are expected for the type of nanostructure synthesized using the proposed methodology. The narrow band at 471 nm indicates that the nanocubes are homogeneous in size. This surface plasmon band is assigned to the (100) plane, indicating a face-centered cubic silver structure. Bands at 350 and 400 nm are assigned to the surface plasmon of the corners and edges of the cubes, respectively, so the presence of these bands indicates formation of the perfect cubes.

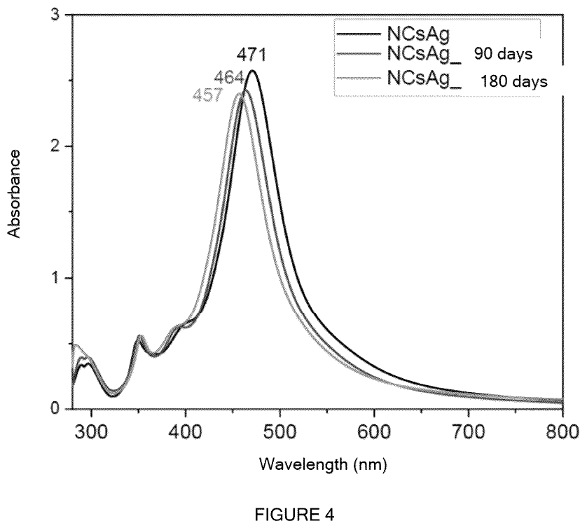

The UV-Vis spectra of NCsAg synthesized with no purification over 180 days were evaluated, stored in a refrigerator at approximately 4° C. (FIG. 4). It is possible to observe a shift to shorter wavelengths from the 471 nm band to 457 nm, suggesting that the NCsAg, even when stored in a refrigerator continued to react slowly. Furthermore, the shoulder at 400 nm also loses some definition after 180 days. These minor changes can affect the reproducibility of performance as a SERS substrate over time, showing that it is necessary to include a purification step to ensure completion of the reaction.

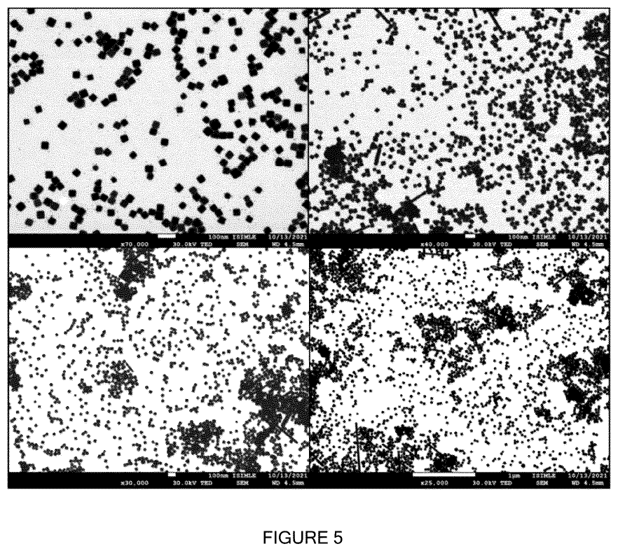

The UV-Vis spectroscopy results are indicative of cube formation. However, to confirm the morphology and size, analysis was performed scanning electron using microscopy (SEM). Micrographs are shown in FIG. 5, which validate the presence of cubes and the efficiency of the synthesis, and were obtained for the purified NCsAg, as the solvent used for the synthesis and the excess of organic reagents such as PVP do not allow obtaining high quality images.

Some parameters were assessed and optimized to obtain the results shown above, since any variation in the concentration and number of reagents involved in the synthesis can generate changes in shape, size and quantity of synthesized material. Concentration and amount of added Na₂S can be considered the most critical parameter and therefore was the main parameter for optimizing the synthesis method, with the optimized values shown in the above procedure.

Along with the variation in the amount and concentration of Na₂S, the synthesis time is also considered critical. During the optimization process, different synthesis times were assessed until the optimal one was reached. This optimization was accompanied by the analysis of UV-Vis spectra as well as scanning electron microscopy images.

The predominant morphology was shown to be cubic, even in low magnification images, and the presence of other morphologies was not detected, such as wires that may be common byproducts of this type of synthesis. The cubes have edges of 41±3 nm, with values ranging from 31 to 48 nm. These results corroborate the results of UV-Vis absorption spectroscopy.

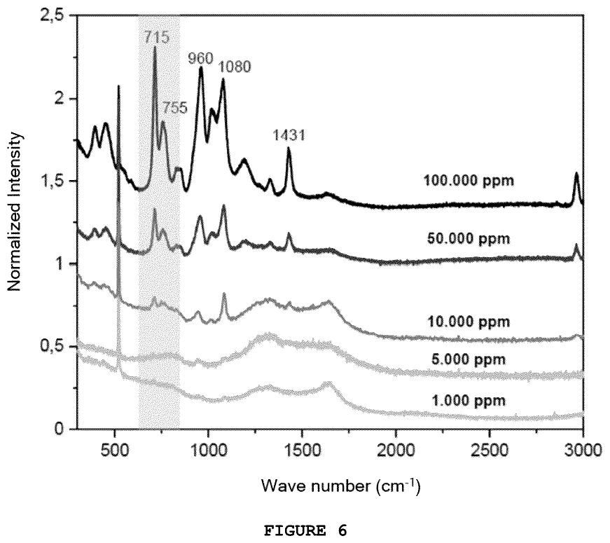

Firstly, conventional Raman spectroscopy analyzes were carried out on standard solutions of organic compounds containing the phosphonate group in high concentrations to determine the detection limit and to characterize their vibrational modes. By way of example, analysis using nitrilotrimethylphosphonic acid (ATMP) is presented in FIG. 6 and the characteristic vibrational modes of this molecule are shown in Table 1. The results show that the vibrational modes of ATMP do not appear in concentrations equal to or lower than 5,000 mg kg⁻¹, showing that for these concentrations the use of surface-enhanced Raman technique is required.

TABLE 1
Assignment of the main bands observed in
the Raman spectrum of the ATMP inhibitor

| Raman shift (cm⁻¹) | Vibrational mode |
|---|---|
| 713 | νs(OH)—P—C |
| 755 | νas(OH)—P—C |
| 961 | νP—O |
| 1082 | νC—N |
| 1435 | δCH2 |

When preparing the SERS substrate for analysis, a drop of the sample with the nanoparticle suspension is placed on a silicon substrate and allowed to dry. A region with a large amount of material is formed, mainly at the edge, and the spectra are obtained in this region, which, for having a higher concentration of the analyte promotes the enhancement of the local electromagnetic field and, as a consequence, the Raman signal.

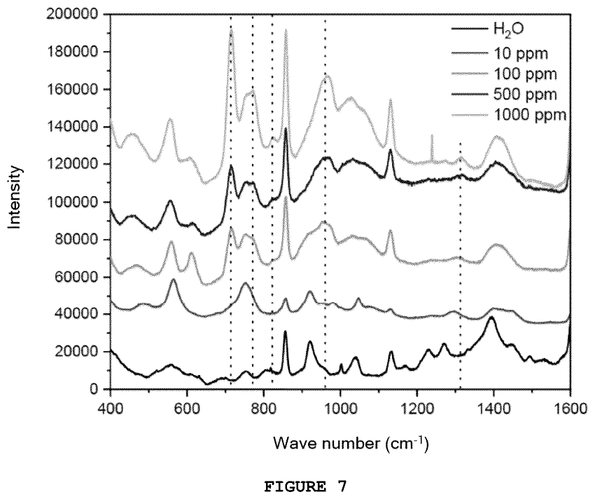

FIG. 7 shows the SERS spectra of the ATMP in the region between 400 and 1600 cm⁻¹ at different concentrations using purified NCsAg. In the presence of the ATMP analyte, the spectra have a different profile from the blank, but only for concentrations greater than 100 mg/kg this profile does resemble that of the analyte. The main characteristic bands of ATMP are observed from 100 mg/kg, such as at 715 and 765 cm⁻¹ which are assigned to the symmetric and asymmetric stretching of the phosphonate group [νs and ass(OH)-PC] and the band at 961 cm⁻¹ referring to the stretching of the P—O linkage. The bands around 1082 cm⁻¹ and 1435 cm⁻¹ were not well defined.

A trend towards an increased intensity of the SERS signal was observed, mainly in the band at 715 cm⁻¹, with increased concentration of the analyte. Although the SERS signal in the 10 mg/kg concentration spectrum is not characteristic of ATMP, it also has large differences when compared to the blank spectrum, suggesting the presence of the analyte also at such lower concentration.

SERS analysis for scale inhibitors using the described methodology achieves better detection limits and robustness through chemometric data analysis techniques. The spectra obtained at concentrations from 0 to 500 mg/kg were processed with baseline correction using the AWLS algorithm, in order to reduce the effect of instrumental variation and to highlight chemical variation. From the results obtained, it was observed that the technique can be applied to quantitative measurements.

### Advantages of the Disclosure

### Economic Advantages/Yield

From among the advantages of the disclosure, the following stand out:

Development of methodologies using national technology for the determination of phosphonate-based scale inhibitors in process streams will contribute to routine inspection, monitoring and optimization of the amount of chemicals used in oil and gas production, ensuring integrity of equipment and, as a consequence, stability of processes.

Reliability of analytical results in determining the scale inhibitor content.

Minimization of product waste and reduction of production stops associated with fouling by optimizing the amounts used.

Use of the developed SERS method allows the detection and quantification of scale inhibitors, eliminating the use of high and unnecessary amounts of the compound in industrial processes. Optimizing the use of scale inhibitors guarantees a reduction in production costs and guarantees integrity of equipment and transport pipes.

The developed method is based on the specific detection of phosphonate scale inhibitor by surface-enhanced (SERS). This technique has considerable Raman spectroscopy advantages over chromatographic techniques, for example, commonly used for the quantification of phosphorus compounds. The following should be highlighted: simplicity and lower cost of sample preparation methods and availability on the market of portable Raman spectrometers, allowing analyzes to be carried out in the field, that is, on platform operations.

Currently commercially available SERS substrates do not offer a specific methodology for the detection and determination of phosphonates. The developed system covers the construction of the substrate, sample preparation—aiming for efficient analyte/substrate interaction—and the specific detection method for the determination of phosphonate scale inhibitor.

1. A method for building a SERS substrate, the method comprising:
(a) selecting the metal nanoparticles;
(b) purifying and preparing the nanoparticles; and
(C) interacting between an analyte and a substrate;
wherein the method uses surface-enhanced Raman spectroscopy.

2. The method according to claim 1, wherein in step (a) the metal nanoparticles used are silver, gold or a combination of both.

3. The method according to claim 2, wherein the metal nanoparticles are synthesized via chemical reduction using a reflux system, and wherein the nanoparticles are left to heat for one hour in a glycerin bath at 160° C. with anhydrous ethylene glycol, at a constant temperature of 142° C.

4. The method according to claim 3, wherein that while ethylene glycol is heated, solutions of 48 mg/ml AgNO₃ (0.284 mol L⁻¹), 3 mM Na₂S (3 mmol L⁻¹) and 20 mg/ml PVP (PVP, MM≈55, 000, 0.363 mmol L⁻¹) are prepared, wherein after heating, 80 μL of Na S are added to the flask, after 9 minutes 3.75 ml of PVP are added, and then, 1.25 mL of AgNO₃ are poured dropwise onto the solution, with a dripping time of 1 minute, and wherein the suspension remains in reaction for 15 minutes, cools in a water bath for about 5 minutes, and is stored in the refrigerator.

5. The method according to claim 1, wherein step (b) a mixture of nanoparticles and PA acetone in a 1:3 ratio is centrifuged at 3,000 g for 30 minutes, and then supernatant is removed and homogenized for 2 minutes in ultrasound with ethanol PA, and centrifuged at 10,000 g for 10 min, wherein removal of the supernatant and redispersion in ethanol is repeated two more times, with the final supernatant being removed and discarded until 0.8% of the initial volume is reached, followed by the addition of ultrapure water until ⅙ of the initial volume is reached, and wherein the final suspension is homogenized in ultrasound for 2 minutes.

6. The method according to claim 1, wherein step (c) 5 μL of suspension is poured dropwise onto a polycrystalline silicon substrate and, after 1 h of drying, 5 μL of the analyte of interest is poured dropwise, wherein analysis is carried out after complete drying of the second drop containing the analyte solution (around 1 h), and wherein interacting is carried out in an environment with around 30% humidity and a temperature of 20° C.

7. A SERS substrate built by a method of claim 1, the SERS substarte comprising a cubic type and having an intense and thin band at 471 nm, a shoulder at 400 nm, and another band at 350 nm.

8. The SERS substrate according to claim 7, wherein cubes of the cubic type SERS substrate have edges of 41±3 nm, with values ranging from 31 to 48 nm.

9. A method of use of a SERS substrate as defined in claim 7, the method comprising detecting and quantifying the content of phosphonate-based scale inhibitors present in low concentrations in water.

10. The method according to claim 9, further comprising using the SERS substrate for one or more of detergent and dispersant products, in corrosion inhibitors, in water treatment systems, in the textile, in concrete, or in paper industries.
